(19) United States
(12) Patent Application Publication
(10) Pub. No.: US 2013/0117784 A1
(43) Pub. Date: May 9, 2013

(54) SYSTEM AND METHOD FOR DISPLAYING INFORMATION OF TELEVISION ADVERTISED PRODUCT AND RECORDING MEDIA THEREOF

(71) Applicants: Chen-Ming WU, Chiayi City (TW); Wen-Tai Hsieh, Taipei City (TW); Kung-Ming Sung, Kaohsiung City (TW); Tsun Ku, Taipei City (TW); Bo-Chin Tsai, New Taipei City (TW)

(72) Inventors: Chen-Ming WU, Chiayi City (TW); Wen-Tai Hsieh, Taipei City (TW); Kung-Ming Sung, Kaohsiung City (TW); Tsun Ku, Taipei City (TW); Bo-Chin Tsai, New Taipei City (TW)

(21) Appl. No.: 13/328,731

(22) Filed: Dec. 16, 2011

(30) Foreign Application Priority Data
Nov. 8, 2011 (CN) 201110356067.5

(51) Int. Cl. H04N 21/00

(52) U.S. Cl. 725/35

(57) ABSTRACT

A system and a method for displaying information of a television advertised product and a recording media thereof are provided, which are applicable to a server and a mobile device connected via a network. The server stores at least one channel advertisement data and information of product corresponding to each piece of the channel advertisement data. The mobile device sends an advertisement data play instruction, which includes selection information associated with a current television play channel. The server receives the advertisement data play instruction, finds target information of product from the information of product corresponding to the channel advertisement data according to the selection information, the instruction receiving time, and the channel advertisement data, and feeds back the target information of product to the mobile device. The mobile device displays the target information of product.

### CROSS-REFERENCE TO RELATED APPLICATION

This application claims the benefit of Chinese Patent Application No. 201110356067.5, filed on Nov. 08, 2011, which is hereby incorporated by reference for all purposes as if fully set forth herein.

### BACKGROUND OF THE INVENTION

1. Field of Invention

The present invention relates to a system and a method for displaying information of a television advertised product and a recording media thereof, and more particularly to a display system, a display method and a recording media through which related data of a product in an advertisement played on the television can be immediately obtained.

2. Related Art

In the prior art, when consumers are watching advertisements on the television and are interested in an advertised product, they usually obtain the related information of the product in the following manners.

Manner 1: Get the contact information of the manufacturer from the advertisement, and make calls, send letters or emails, or go to the store personally to obtain the information of product, or query the manufacturer or the service personnel in the store for the related product data.

Manner 2: Obtain evaluations made by users of the product from relevant websites or forums in the network.

However, the above manners have the following disadvantages. In Manner 1, it is very likely that the manufacturer may brag about the product in order to sell more, and the evaluation is also not objective, resulting in an unreliable impression of the consumers on the product. In Manner 2, the consumers need to use an electronic apparatus additional to the television system, and the electronic apparatus must have the capability of accessing the network and presenting the web page, so that the consumers are enabled to find relevant evaluations of the product in the network. Moreover, the consumers need to visit different websites to collect data, so as to acquire a comprehensive understanding of the product, and achieve a reliable impression on the product, which is rather time-consuming.

### SUMMARY OF THE INVENTION

To solve the above problems, the present invention provides a system and a method for displaying information of a television advertised product and a recording media thereof, through which related data of a product in an advertisement played on the television can be immediately obtained and presented.

The present invention provides a system for displaying information of a television advertised product, which includes a mobile device and a server.

The mobile device includes a device storage module, a device processing module, and a display module. The device storage module stores selection information. The device processing module reads from the device storage module and sends an advertisement data play instruction including the selection information.

The server is connected to the mobile device, and includes a servo storage module and a servo processing module. The servo storage module stores at least one channel advertisement data and at least one information of product corresponding to each of the channel advertisement data. The servo processing module receives the advertisement data play instruction, finds target information of product from the information of product corresponding to the channel advertisement data according to the selection information, the receiving time of the advertisement data play instruction, and the channel advertisement data, and outputs the target information of product to the mobile device.

The device processing module obtains the target information of product and plays the target information of product on the display module.

The present invention further provides a method for displaying information of a television advertised product, which is applicable to a server and a mobile device connected via a network. The server stores at least one channel advertisement data and at least one information of product corresponding to each piece of the channel advertisement data. The method includes: sending by the mobile device an advertisement data play instruction to the server, in which the advertisement data play instruction includes selection information; performing comparison by the server according to the selection information, the receiving time of the advertisement data play instruction, and the stored at least one channel advertisement data; finding by the server target information of product from the information of product corresponding to the channel advertisement data according to the selection information, the receiving time of the advertisement data play instruction, and the stored at least one channel advertisement data, and outputting the target information of product to the mobile device; and obtaining and displaying by the mobile device the target information of product.

The present invention further provides a recording media, which stores computer readable program codes. A server and a mobile device connected via a network read the program codes, to together perform a method for displaying information of a television advertised product. The server stores at least one channel advertisement data and at least one information of product corresponding to each piece of the channel advertisement data. The process of the method is described above, and the details will not be given herein again.

The present invention is characterized in that, the consumers can immediately obtain related data of the advertised product, for example, immediately learn about comprehensive evaluations from different users on the product, and quickly achieve a reliable impression on the product, to further improve the application of multiple users on the product information in the network. Moreover, the consumers do not need to access the network through an additional electronic apparatus and spend plenty of time to learn about the product, so that the consumers can make a schedule more flexibly. In addition, the system may be integrated with a shopping platform, so that the design and planning of the system become more flexible, to further enhance the practicability of the system.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first system architecture according to an embodiment of the present invention;

FIG. 2 is a schematic view of a second system architecture according to an embodiment of the present invention;

FIG. 3 is a schematic view of a third system architecture according to an embodiment of the present invention;

FIG. 4 is a schematic view of a fourth system architecture according to an embodiment of the present invention;

FIG. 5 is a schematic structural view of a server according to an embodiment of the present invention;

FIG. 6 is a schematic view of a process of a method for displaying information of a television advertised product according to an embodiment of the present invention;

FIG. 7 is a schematic view of a pre-process of the method for displaying information of a television advertised product according to an embodiment of the present invention; and

FIG. 8 is a schematic view of another pre-process of the method for displaying information of a television advertised product according to an embodiment of the present invention.

### DETAILED DESCRIPTION OF THE INVENTION

Preferred embodiments of the present invention will be described in detail below with the accompanying drawings.

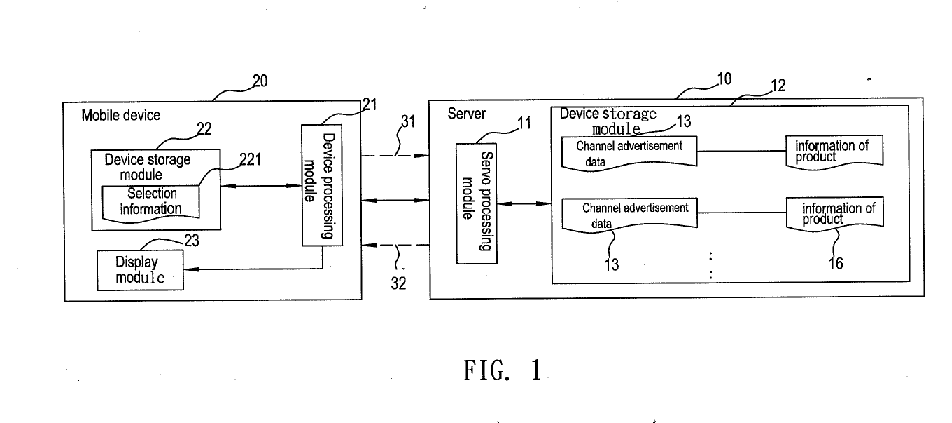

FIG. 1 is a schematic view of a first system architecture according to an embodiment of the present invention. The system in this embodiment includes a mobile device 20 and a server 10 connected via a network. The mobile device 20 is capable of controlling a digital television apparatus to perform channel switching, and may be a smart phone, a tablet computer, or any related electronic device having the network communication capability and pattern display capability, but the present invention is not limited thereto. For example, the mobile device 20 may operate via an operating interface (for example, a virtual remote control) generated by an application program or via specified keys of the mobile device 20, and communicate with the digital television apparatus through a wireless transmission mode (for example, infrared rays, blue-tooth, or Wi-Fi) of the mobile device 20 to control the digital television apparatus to perform channel switching.

The mobile device 20 includes a device storage module 22, a device processing module 21, and a display module 23. Selection information 221 is stored in the device storage module 22.

The server 10 is connected to the mobile device 20 via a network. The server 10 includes a servo storage module 12 and a servo processing module 11. The servo storage module 12 stores at least one channel advertisement data 13 and at least one information of product 16 corresponding to each the channel advertisement data 13.

The device processing module 21 reads the selection information 221, and transmits an advertisement data play instruction 31 including the selection information 221 to the server 10.

The servo processing module 11 obtains the advertisement data play instruction 31, finds target information of product 32 from the information of product 16 corresponding to the channel advertisement data 13 according to the selection information 221 included in the advertisement data play instruction 31, the receiving time of the advertisement data play instruction 31, and each piece of the channel advertisement data 13, and feeds back the target information of product 32 to the mobile device 20.

The device processing module 21 plays the target information of product 32 on the display module 23 for the reference of the user. The information of product 16 includes, for example, the appearance, price, practicability, and evaluation of the product, and if the product is food, the information of product 16 may further include freshness and taste, or other related features of the product, which is not limited herein.

Furthermore, each piece of the information of product 16 may include a product purchasing platform path, which contains a network address of an online shopping platform of the manufacturer. When the display module 23 of the mobile device 20 presents the information of product 16, the product purchasing platform path is presented at the same time. The user may select the product purchasing platform path via a control interface of the mobile device 20. Thereby, the mobile device 20 is connected to the shopping platform of the manufacturer, and the user may purchase the product from the manufacturer through the shopping platform.

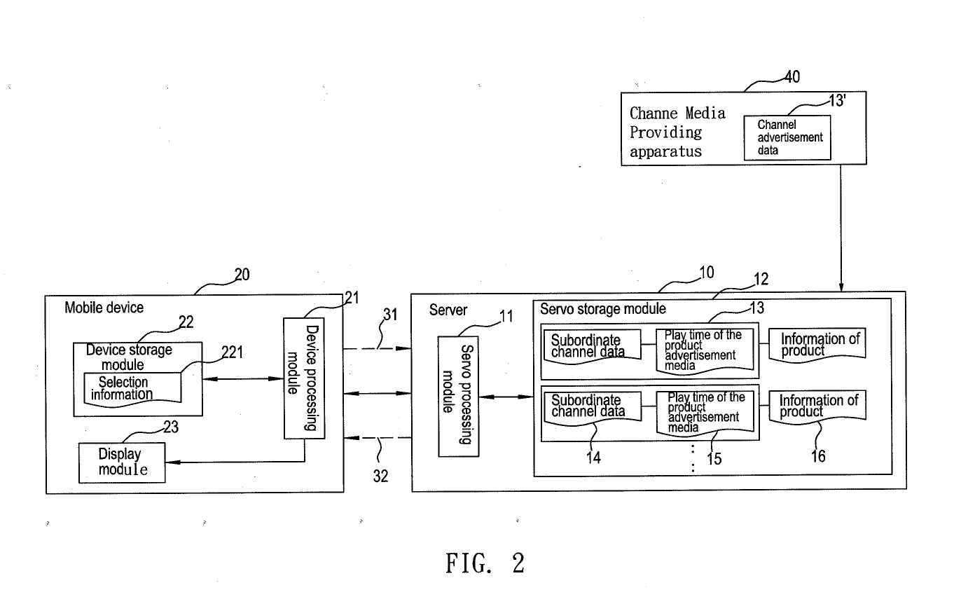

FIG. 2 is a schematic view of a second system architecture according to an embodiment of the present invention. Different from the embodiment in FIG. 1, a channel media providing apparatus 40 is connected to the server 10 in this embodiment. The channel advertisement data 13 is provided by the channel media providing apparatus 40 in the media industry. The servo processing module 11 may update the channel advertisement data 13 stored by the servo storage module 12 according to the obtained channel advertisement data 13′.

The channel advertisement data 13′ may also be input via a man-machine interface of the server 10, or the server 10 is connected to an external storage device, to obtain the channel advertisement data 13 for data update.

However, the channel advertisement data 13 may be a channel advertisement play list recording subordinate channel data 14 of product advertisement media and the play time 15 of the product advertisement media played in each channel. The information of product 16 corresponding to each piece of the channel advertisement data 13 is the information of product 16 corresponding to each of the product advertisement media. The selection information 221 is television channel information generated by the operation of the user via an operating interface (for example, a virtual remote control) of the mobile device 20.

Therefore, the servo processing module 11 compares the television channel information with the subordinate channel data 14, and compares the instruction receiving time with the play time 15 of the product advertisement media played in each channel, to obtain the most appropriate information of product 16 as the target information of product 32.

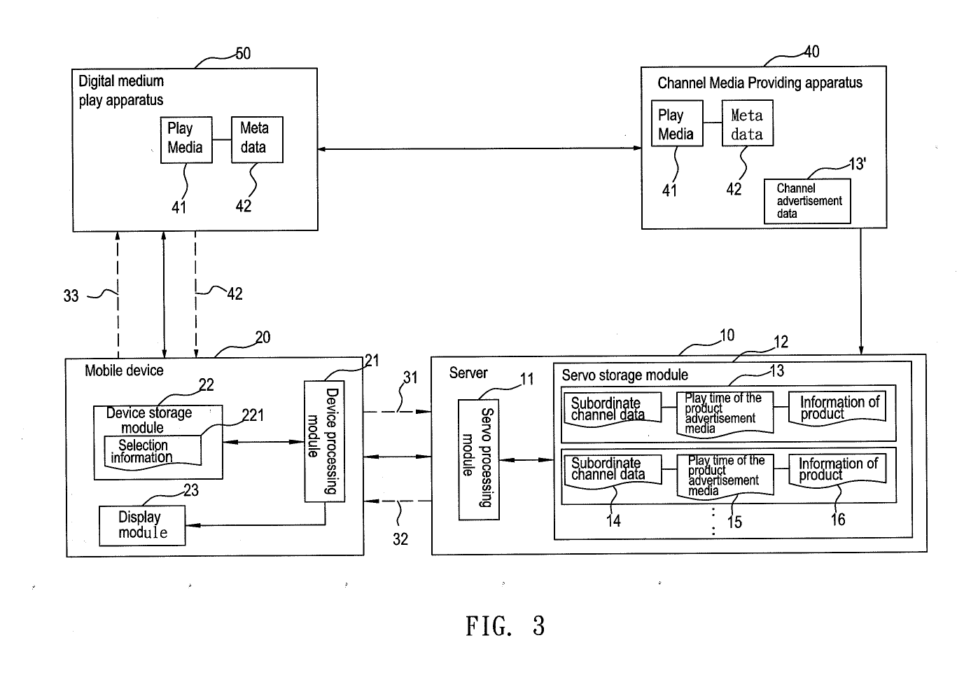

FIG. 3 is a schematic view of a third system architecture according to an embodiment of the present invention. Different from the above embodiments, the system in this embodiment further includes a digital media play apparatus 50. The digital media play apparatus 50 may be a digital television set, or a combination of a television set and a digital set top box (STB).

When the user inputs television channel information 33 through the mobile device 20, the device processing module 21 transmits the television channel information 33 to the digital media play apparatus 50. The digital media play apparatus 50 selects a playing channel by switching the current playing channel to a playing channel designated by the television channel information 33, obtains a play media 41 provided by the channel media providing apparatus 40 through the playing channel, and plays the play media 41. The device processing module 21 stores the television channel information 33 in the device storage module 22, in which the television channel information 33 is used as the selection information 221 and integrates it into the advertisement data play instruction.

Furthermore, the digital media play apparatus 50 obtains meta data 42 corresponding to the play media 41 when obtaining the play media 41. When the play media 41 is the forgoing product advertisement media, the meta data 42 may include the product name, product model, producer, and product features, and may also include the product description, manufacturer, purchasing platform, and other related data of the product. The meta data 42 may be transmitted by the digital media play apparatus 50 to the mobile device 20, and the device processing module 21 may use the meta data 42 as the selection information 221 when creating the advertisement data play instruction 31.

The servo processing module 11 may obtain the meta data 42 from the advertisement data play instruction 31, and compare the meta data 42 with the information of product 16 in the data comparison process, to find the target information of product 32. However, the information of product 16 must have data or character the same as or matching or mutually depending on or corresponding to the meta data 42.

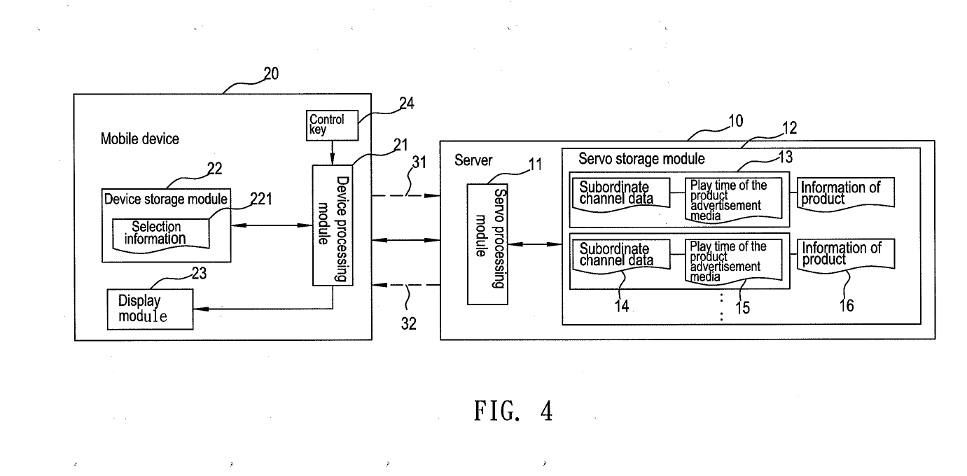

FIG. 4 is a schematic view of a fourth system architecture according to an embodiment of the present invention. Different from the above embodiments, the mobile device 20 further includes a control key 24 in this embodiment. The control key 24 may be a software key or a hardware key depending on the type of the mobile device 20. Only when the device processing module 21 determines that the control key 24 is pressed, the device processing module 21 starts to generate the advertisement data play instruction 31. Thereby, the user may control the time for obtaining the information of product 16.

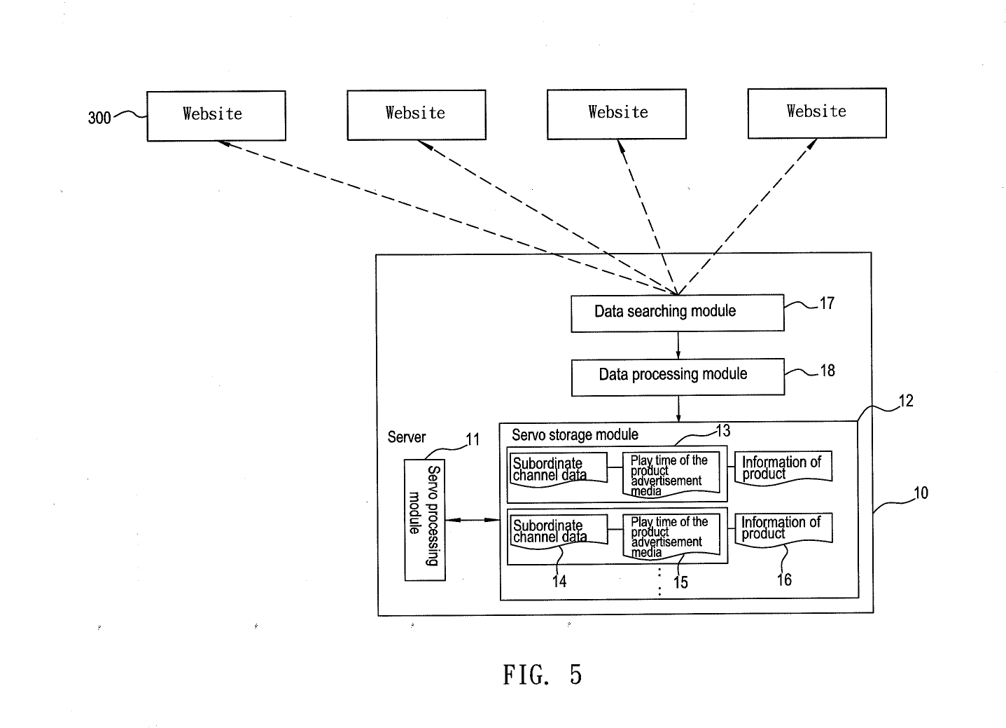

FIG. 5 is a schematic structural view of the server 10 according to an embodiment of the present invention. The server 10 includes a data searching module 17 and a data processing module 18 in this embodiment. The data searching module 17 stores at least one searching rule corresponding to the product of the channel advertisement data 13, so as to search at least one searching data according the searching rule via the network. The searching rule includes at least one key word, for example, the meta data 42, the product name, or any other key word that can be used for searching and related to the product. When the key word is used for searching, the found searching data also includes the key word. Alternatively, the searching rule includes the address of at least one website 300, and the content of the searching data is data stored in the website specified by the searching rule. However, the data searching method is not limited thereto, and any method that can be used for data collection is applicable.

The data processing module 18 is used for analyzing the collected searching data, forming evaluation data for the product of the product advertisement media according to the product corresponding to the searching data, and storing the evaluation data as the information of product 16 corresponding to each the channel advertisement data. However, the data analysis method may be a fuzzy analysis method, an artificial neural data analysis method, or any other method that can be used for data analysis, which is not limited herein.

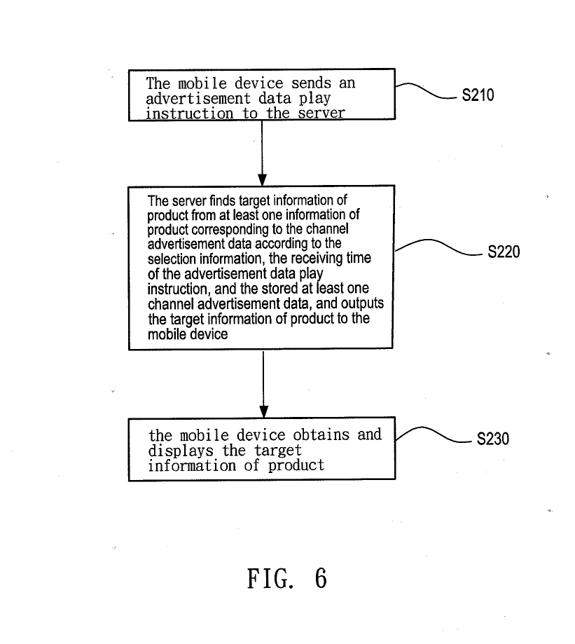

FIG. 6 is a schematic view of a process of a method for displaying information of a television advertised product according to an embodiment of the present invention, which is applicable to a server 10 and a mobile device 20 connected via a network. A better understanding can be achieved with reference to FIG. 1 to FIG. 5 at the same time. The process of the method includes the following steps.

The mobile device 20 sends an advertisement data play instruction 31 to the server 10 (S210). In this step, the device processing module 21 reads the selection information 221, and transmits the advertisement data play instruction 31 including the selection information 221 to the server 10. The selection information 221 may be the television channel information 33 or the meta data 42.

Referring to FIG. 4, the mobile device 20 further includes a control key 24. Only when the device processing module 21 determines that the control key 24 is pressed, the device processing module 21 starts to generate the advertisement data play instruction 31 to trigger Step S210.

The server 10 finds target information of product 32 from at least one information of product 16 corresponding to the channel advertisement data 13 according to the selection information 221, the receiving time of the advertisement data play instruction 31, and the stored at least one channel advertisement data 13, and outputs the target information of product 32 to the mobile device 20 (S220).

The servo processing module 11 obtains the selection information 221 from the advertisement data play instruction 31. Different data comparison manners are provided in the following based on different selection information 221.

(1) If the selection information 221 is the television channel information 33, and the channel advertisement data is a channel advertisement play list, the servo processing module 11 compares the television channel information 33 with the subordinate channel data 14, and compares the receiving time of the advertisement data play instruction 31 with the play time 15 of the product advertisement media.

(2) If the selection information 221 is the meta data 42, the servo processing module 11 compares the meta data 42 with the information of product 16, to find the target information of product 32.

Afterwards, the server 10 outputs the target information of product 32 to the mobile device 20.

The mobile device 20 obtains and displays the target information of product 32 (S230). The device processing module 21 plays the target information of product 32 on the display module 23. The presented data includes, for example, the appearance, price, practicability, and evaluation of the product, or other related features of the product, which is not limited herein.

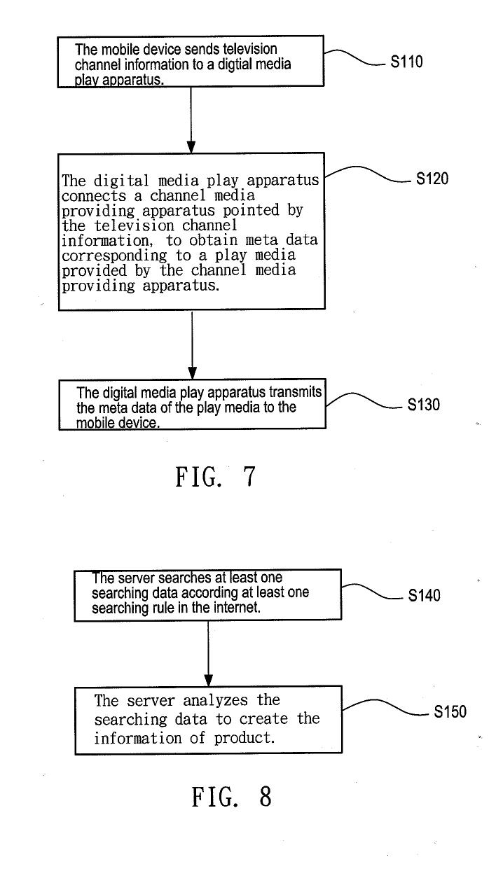

FIG. 7 is a schematic view of a pre-process of the method for displaying information of a television advertised product according to an embodiment of the present invention, which is applicable to a server 10 and a mobile device 20 connected via a network. A better understanding can be achieved with reference to FIG. 1 to FIG. 5 at the same time. The process includes the following steps.

The mobile device 20 sends television channel information 33 to a digital media play apparatus 50 (S110). When the user inputs the television channel information 33 via the operating interface of the mobile device 20, the device processing module 21 transmits the television channel information 33 to the digital media play apparatus 50. The television channel information 33 is also stored in the device storage module 22, to serve as the selection information 221.

The digital media play apparatus 50 connects a channel media providing apparatus 40 pointed by the television channel information 33, to obtain meta data 42 corresponding to a play media 41 provided by the channel media providing apparatus 40 (S120). The meta data 42 corresponding to the play media 41 is transmitted by the digital media play apparatus 50 to the mobile device 20 (S130).

In Step S210, the device processing module 21 uses the meta data 42 as the selection information 221 when creating the advertisement data play instruction 31. In Step S220, the servo processing module 11 compares the meta data 42 with the information of product 16, to together find the target information of product 32.

FIG. 8 is a schematic view of another pre-process of the method for displaying information of a television advertised product according to an embodiment of the present invention, which is applicable to a server 10 and a mobile device 20 connected via a network. A better understanding can be achieved with reference to FIG. 1 to FIG. 5 at the same time.

The server 10 searches at least one searching data according at least one searching rule in the Internet (S140). Referring to FIG. 5, the data searching module 17 is used for searching at least one searching data according the searching rule in the Internet. The searching rule includes at least one key word, so that the found searching data also includes the key word. Alternatively, the searching rule includes the address of at least one website 300, and the content of the found searching data is data stored in the website specified by the searching rule.

The server 10 analyzes the searching data to create the information of product 16 (S150). In view of the above, the data processing module 18 may use a fuzzy analysis method, an artificial neural data analysis method, or any other type of a data analysis method to analyze the collected searching data, and form the information of product 16 of the product of the product advertisement media by using the collected searching data.

There is no specific sequence to implement the process in FIG. 7 and the process in FIG. 8. That is to say, Steps S110 to S130 can be performed before Steps S140 to S150; or Steps S140 to S150 are performed before Steps S110 to S130; or the process in FIG. 7 and the process in FIG. 8 are performed at the same time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for displaying information of a television advertised product, comprising:
a mobile device, comprising a device storage module, a device processing module, and a display module, wherein the device storage module stores selection information, and the device processing module reads from the device storage module and sends an advertisement data play instruction comprising the selection information; and
a server, connected to the mobile device via a network, and comprising a servo storage module and a servo processing module, wherein the servo storage module stores at least one channel advertisement data and at least one information of product corresponding to each of the channel advertisement data, and the servo processing module receives the advertisement data play instruction, finds target information of product from the at least one information of product corresponding to the channel advertisement data according to the selection information, the receiving time of the advertisement data play instruction, and the at least one channel advertisement data, and outputs the target information of product to the mobile device,
wherein the device processing module is further used for obtaining the target information of product and playing the target information of product on the display module.

2. The system for displaying information of a television advertised product according to claim 1, wherein the at least one channel advertisement data stored by the server is provided by a channel media providing apparatus to the server.

3. The system for displaying information of a television advertised product according to claim 1, wherein the selection information is television channel information, the channel advertisement data is a channel advertisement play list recording the play time of the product advertisement media in each channel, and the at least one information of product corresponding to each piece of the channel advertisement data is the information of product corresponding to each of the product advertisement media.

4. The system for displaying information of a television advertised product according to claim 1, wherein the mobile device is used for sending television channel information to a digital media play apparatus to select a playing channel of the digital media play apparatus, and the television channel information is generated via an operating interface provided by the mobile device.

5. The system for displaying information of a television advertised product according to claim 1, further comprising a digital media play apparatus, used for receiving television channel information sent by the mobile device, and connecting a channel media providing apparatus pointed by the television channel information, to obtain meta data corresponding to a play media provided by the channel media providing apparatus, and transmit the meta data of the play media to the mobile device, wherein the meta is used as the selection information.

6. The system for displaying information of a television advertised product according to claim 5, wherein the device processing module uses the meta data as the selection information and integrates it into the advertisement data play instruction, so that the servo processing module compares the meta data with the information of product to find the target information of product.

7. The system for displaying information of a television advertised product according to claim 1, wherein the server further comprises a data searching module and a data processing module, the data searching module stores at least one searching rule corresponding to the product of the channel advertisement data and searches at least one searching data according the at least one searching rule via the network, and the data processing module analyzes the searching data to create the at least one information of product corresponding to each piece of the channel advertisement data.

8. The system for displaying information of a television advertised product according to claim 1, wherein the digital media play apparatus is a digital television set or a digital set top box (STB).

9. A method for displaying information of a television advertised product, applicable to a server and a mobile device connected via a network, wherein the server stores at least one channel advertisement data and at least one information of product corresponding to each piece of the channel advertisement data, the method comprising:
sending by the mobile device an advertisement data play instruction to the server, wherein the advertisement data play instruction comprises selection information;
finding by the server target information of product from the at least one information of product corresponding to the channel advertisement data according to the selection information, the receiving time of the advertisement data play instruction, and the stored at least one channel advertisement data, and outputting the target information of product to the mobile device; and
displaying by the mobile device the target information of product.

10. The method for displaying information of a television advertised product according to claim 9, wherein the at least one channel advertisement data stored by the server is provided by a channel media providing apparatus to the server.

11. The method for displaying information of a television advertised product according to claim 9, wherein the selection information is television channel information, the channel advertisement data is a channel advertisement play list recording the play time of product advertisement media in each channel, and the at least one information of product corresponding to each piece of the channel advertisement data is the information of product corresponding to each of the product advertisement media.

12. The method for displaying information of a television advertised product according to claim 9, wherein before the mobile device sends the advertisement data play instruction to the server, the method further comprises:
sending by the mobile device television channel information to a digital media play apparatus, to select a playing channel of the digital media play apparatus, wherein the television channel information is generated via an operating interface provided by the mobile device.

13. The method for displaying information of a television advertised product according to claim 9, wherein before the mobile device sends the advertisement data play instruction to the server, the method further comprises:
sending by the mobile device television channel information to a digital media play apparatus;
connecting by the digital media play apparatus a channel media providing apparatus pointed by the television channel information, to obtain meta data corresponding to a play media provided by the channel media providing apparatus; and
transmitting by the digital media play apparatus the meta data of the play media to the mobile device, wherein the meta data is used as the selection information.

14. The method for displaying information of a television advertised product according to claim 13, wherein when the server finds the target information of product from the at least one information of product corresponding to the channel advertisement data according to the selection information, the receiving time of the advertisement data play instruction, and the stored at least one channel advertisement data, and outputs the target information of product to the mobile device, the method further comprises comparing the meta data with the information of product to find the target information of product.

15. A recording media, storing computer readable program codes, wherein a server and a mobile device connected via a network read the program codes, to together perform a method for displaying information of a television advertised product, and the server stores at least one channel advertisement data and at least one information of product corresponding to each piece of the channel advertisement data, the method comprising:
sending by the mobile device an advertisement data play instruction to the server, wherein the advertisement data play instruction comprises selection information;
finding by the server target information of product from the at least one information of product corresponding to the channel advertisement data according to the selection information, the receiving time of the advertisement data play instruction, and the stored at least one channel advertisement data, and outputting the target information of product to the mobile device; and
obtaining and displaying by the mobile device the target information of product.

16. The recording media according to claim 15, wherein the at least one channel advertisement data stored by the server is provided by a channel media providing apparatus to the server.

17. The recording media according to claim 15, wherein the selection information is television channel information, the channel advertisement data is a channel advertisement play list recording the play time of product advertisement media in each channel, and the at least one information of product corresponding to each piece of the channel advertisement data is the information of product corresponding to each of the product advertisement media.

18. The recording media according to claim 15, wherein before the mobile device sends the advertisement data play instruction to the server, the method further comprises:
sending by the mobile device television channel information to a digital media play apparatus, to select a playing channel of the digital media play apparatus, wherein the television channel information is generated via an operating interface provided by the mobile device.

19. The recording media according to claim 15, wherein before the mobile device sends the advertisement data play instruction to the server, the method further comprises:
sending by the mobile device television channel information to a digital media play apparatus;
connecting by the digital media play apparatus a channel media providing apparatus pointed by the television channel information, to obtain meta data corresponding to a play media provided by the channel media providing apparatus; and
transmitting by the digital media play apparatus the meta data of the play media to the mobile device, wherein the meta data is used as the selection information.

20. The recording media according to claim 19, wherein when the server finds the target information of product from the at least one information of product corresponding to the channel advertisement data according to the selection information, the receiving time of the advertisement data play instruction, and the stored at least one channel advertisement data, and outputs the target information of product to the mobile device, the method further comprises comparing the meta data with the information of product to find the target information of product.
